(19) United States
(12) Patent Application Publication
(10) Pub. No.: US 2019/0200708 A1
(43) Pub. Date: Jul. 4, 2019

(54) ATHLETIC SHOE WITH CLEAT RELEASING SYSTEM

(71) Applicant: Kurt Requa, Rochester, MN (US)

(72) Inventor: Kurt Requa, Rochester, MN (US)

(73) Assignee: GatesReed LLC, Rochester, MN (US)

(21) Appl. No.: 16/165,132

(22) Filed: Oct. 19, 2018

Related U.S. Application Data
(60) Provisional application No. 62/611,509, filed on Dec. 28, 2017.

(51) Int. Cl. A43C 15/16; A43B 5/02; A43C 15/02; A43B 3/00; G01L 5/00

(52) U.S. Cl. CPC A43C 15/161; A43B 5/02; A43C 15/167; A43B 3/0005; G01L 5/0052; A43C 15/02

(57) ABSTRACT

An athletic shoe includes a sole having one or more anchors, a protrusion attachable to each of the anchors, and a releasing system adapted to release the protrusions from the anchors when a predetermined condition is experienced by the sole. In one version, the releasing system includes a portion of the protrusion that is receivable in the anchor and wherein the portion and the anchor are magnetically attracted to one another. In one version, the releasing system includes a sensor that detects a condition, and the releasing system causes the protrusion to be released from the anchor when the condition exceeds a predetermined level.

### PRIORITY

The present application claims the benefit of domestic priority based on U.S. Provisional Patent Application 62/611,509 filed on Dec. 28, 2017, the entirety of which is incorporated herein by reference.

### BACKGROUND

In recent years, leg injuries have become rampant in both amateur and professional sports. Knees, ankles, and the bones of the lower leg are particularly susceptible to injury during both contact and non-contact activities.

FIG. 1 shows an athlete 10 engaged in an athletic activity. The athlete is wearing conventional athletic shoes 20 equipped with one or more cleats extending from the soles of the conventional athletic shoes 20. The purpose of the cleats is to provide traction for the athlete during the athletic activity. Cleats have been used by athletes for decades in sports such as baseball, football, soccer, and golf. They allow an athlete to grip the playing field and promote stability.

However, cleats can also cause or at least contribute to injuries during the athletic activity. Sometimes the cleats will provide too much traction and act to lock an athlete's foot to the ground, as shown at 30. When the athlete's foot is locked to the ground, a force applied to the lower leg either externally by another athlete or object or internally by a twisting or propulsion of the athlete can transfer excessive force to the hard and/or soft tissue of the athlete and lead to injury. In the example shown in FIG. 1, the cleats can get caught in the ground and prevent rotation of the shoe. As the athlete rotates, a twisting of the lower leg occurs which can cause injury to the ankle, knee, and/or bones of the leg. Whereas, if the athletic shoe 20 had been allowed to rotate on the ground, there is a lower chance that injury might have occurred. This risk can be even greater when another athlete, such as a football player trying to make a tackle, contacts the leg of an athlete. If the athlete's foot is locked to the ground by too much traction, then the foot is not able to give way when the impact force is applied to the leg, and the resulting force can cause severe hard and/or soft tissue damage.

Therefore, there is a need for an improved athletic shoe that provides traction for an athlete in a safer manner. There is further a need for an athletic shoe that has releasable cleats. There is still further a need for an athletic shoe with releasable cleats where the necessary release force is adjustable.

### SUMMARY

The present invention satisfies these needs. In one aspect of the invention, an athletic shoe provides traction while reducing the risk of injury of an athlete.

In another aspect of the invention, an athletic shoe is equipped with one or more cleats that automatically release under predetermined conditions.

In another aspect of the invention, an athletic shoe is equipped with one or more cleats that are releasable from the shoe under adjustable conditions.

In another aspect of the invention, an athletic shoe comprises a sole comprising an anchor, a protrusion attachable to the anchor, and a releasing system adapted to release the protrusion from the anchor when a predetermined condition is experienced by the sole. The releasing system comprises a portion of the protrusion that is receivable in the anchor and wherein the portion and the anchor are magnetically attracted to one another.

In another aspect of the invention, an athletic shoe comprises a sole comprising an anchor, a protrusion attachable to the anchor, and a releasing system adapted to release the protrusion from the anchor, wherein the releasing system comprises a sensor that detects a condition and wherein the releasing system causes the protrusion to be released from the anchor when the condition exceeds a predetermined level.

In another aspect of the invention, a method for providing selective traction for a user wearing an athletic shoe comprises providing an athletic shoe with a sole having a protrusion extending from its sole, detecting a condition, and causing the sole to have reduced traction when the detected condition exceeds a predetermined level.

### DRAWINGS

These features, aspects, and advantages of the present invention will become better understood with regard to the following description, appended claims, and accompanying drawings which illustrate exemplary features of the invention. However, it is to be understood that each of the features can be used in the invention in general, not merely in the context of the particular drawings, and the invention includes any combination of these features, where:

FIG. 1 is a schematic perspective view of an athlete engaged in an athletic activity;

FIG. 2A is a schematic perspective view of the bottom of an athletic shoe with a releasable cleat system according to one version of the invention;

FIG. 2B is a schematic sectional side view of a releasable cleat system according to one version of the invention with the cleat attached;

FIG. 2C is a schematic sectional side view of the releasable cleat system of FIG. 2B with the cleat released;

FIG. 3A is a schematic perspective view of the bottom of an athletic shoe with a releasable cleat system according to another version of the invention;

FIG. 3B is a schematic sectional side view of a releasable cleat system according to a version of the invention with the cleat attached;

FIG. 3C is a schematic sectional side view of the releasable cleat system of FIG. 3B with the cleat released;

FIG. 3D is a schematic sectional side view of a releasable cleat system according to another version of the invention with the cleat attached; and

FIG. 3E is a schematic sectional side view of the releasable cleat system of FIG. 3D with the cleat released.

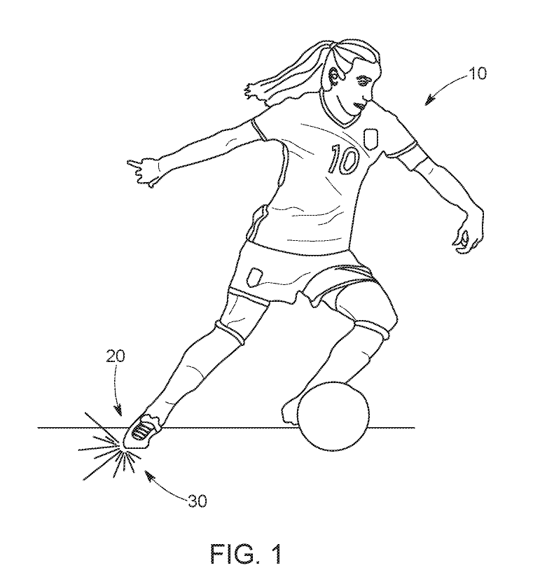

### DESCRIPTION

The present invention relates to athletic shoes and footwear. In particular, the invention relates to an athletic shoe with a texture or cleat releasing system. Although the invention is illustrated and described in the context of being useful for athletic activities, the present invention can be used in other ways, as would be readily apparent to those of ordinary skill in the art. Accordingly, the present invention should not be limited just to the examples and embodiments described herein.

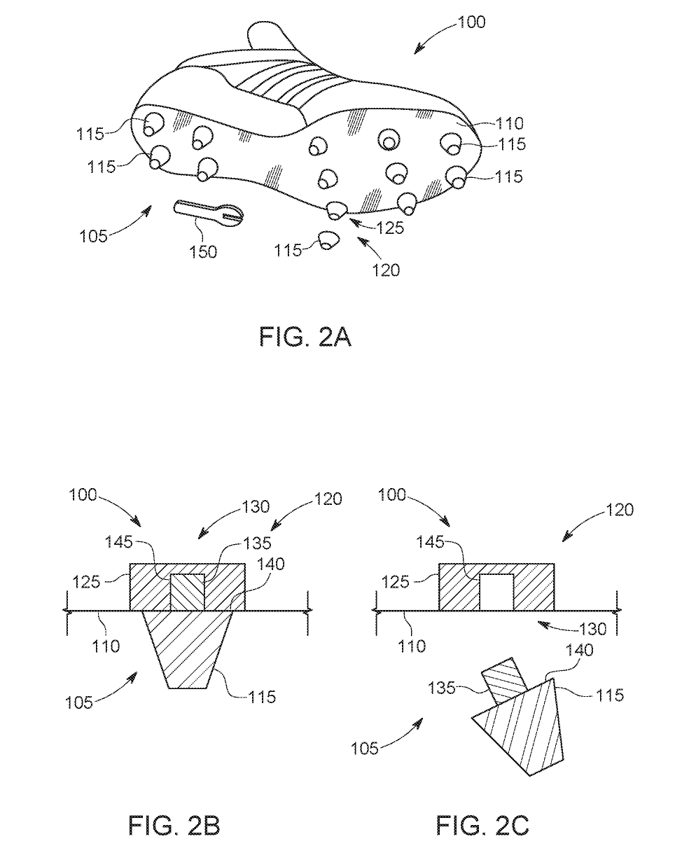

FIG. 2A shows an athletic shoe 100 according to one version of the present invention. The athletic shoe 100 can be any type of footwear intended to be used by an athlete or other wearer and that provides traction for the wearer during a physical activity, such as a sporting activity. Examples of sporting activities include football, baseball, soccer, golf, and the like. The athletic shoe 100 includes a bottom 105 having a sole 110 designed to contact the ground or other playing surface. Extending from the sole 110 are one or more cleats 115. By cleat it is meant any protrusion extending downwardly from the sole 110 or other portion of the shoe 100 and which is intended to provide additional traction for the wearer of the athletic shoe 100. The cleat 115 can be made of any suitable material such as one or more of polyethylene terephthalate (PET), polyethylene (PE) of multiple densities and multiple molecular weights, polypropylene (PP), polyesters, nylons, polytetrafluoroethylene (PTFE), polyurethane (PU), thermoplastic polyurethanes (TPU), polypropylene (PP), polystyrene—expanded or extruded (PS), polyvinylchloride (PVC), polychlorotrifluoroethylene (PCTFE), copolyamid, polybutadiene, ethylene propylene diene monomer (M-class) rubber (EPDM), ethylene-vinyl acetate, polyacrylates, fluoroelastomers, perfluoro-elastomers, tetrafluoro ethylene/propylene rubbers, polydimethylsiloxane, silicone rubber, latex rubber (vulcanized or not), polyurethane urea elastomer, silastic, sorbothane, styrene-butadiene, nitrile rubber, magnetorheological elastomer, phenolic resins, polyaramid-fiber composite filled polymers, polyamide-fiber composite filled polymers, polyacrylonitrile (PAN), poly(methyl methacrylate) (PMMA), epoxy, vinyl ester resins, silicone resins, poly(p-phenylene-2, 6-benzobisoxazole)-(PBO-) fiber composite filled polymers, neoprene (with and without fiber-composite filling), polyimide, acrylonitrile butadiene styrene (ABS), composite-filled polymers previously mentioned (carbon powder mixed with PET, low-density polyethylene (LDPE), high-density polyethylene (HDPE), PS, PU, ABS, etc.) and fiber glass mat, aligned-chopped fibers or randomly-chopped fibers mixed with PET, HDPE, LDPE, PS, PU, ABS, etc.), polyoxybenzylmethyleneglycolanhydride (e.g., Bakelite), phenolic resins, urea-formaldehyde, polyisocyanurate, polyhexahydrotriazine, magnetorheological elastomer, benzoxazines, thermoset phenolic laminate materials, melamine formaldehyde, and mixtures and derivatives thereof. In one particular version, the cleat 115 is made of nylon or polyurethane molded to one or more steel posts.

The athletic shoe 100 of the version of FIG. 2A includes a cleat releasing system 120 that allows for one or more cleats 115 to be released from the sole 110 of the athletic shoe 100. The cleat releasing system 120 include an anchor 125 in the sole 110 that engages a cleat 115 in a manner that allows the cleat 115 to be attached to the sole 110 under certain conditions and released from the sole 110 under certain conditions. For example, the cleat releasing system 120 can be configured so that the cleat 115 is released when a predetermined amount of force is experienced at the foot of the athlete wearing the athletic shoe 100. By releasing the cleat 115 at that time, the traction will be reduced and the foot will more easily be able to slide or move along the ground, thereby reducing the stress and strain applied to the lower leg and its joints.

A version of a cleat releasing system 120 is shown in FIGS. 2B and 2C. The cleat releasing system 120 includes the anchor 125 and a portion of the cleat 115 that engages the anchor 120. In this version, the cleat 115 includes a magnetic breakaway mechanism 130. The magnetic breakaway mechanism 130 is made up of a stem 135 attached to the top surface 140 of the cleat 115. The stem 135 is made of a magnetic material. By magnetic material it is meant any material or object that produces a magnetic field that creates a force that pulls on ferromagnetic materials. Examples of magnetic material include one or more of magnetorheological elastomers, steel, nickel, cobalt, iron, manganese, nickel alloy, cobalt iron, rare-Earth metals (i.e., Neodymium), ferrite, electromagnets, and the like. The breakaway mechanism 130 further includes an anchor 125 that is made at least in part of a ferromagnetic material, such as one or more of magnetorheological elastomers, steel, nickel, cobalt, iron, manganese, nickel alloy, cobalt iron, rare-Earth metals (i.e., Neodymium), ferrite, electromagnets, and the like. The anchor 120 includes a cavity 145 into which the stem 135 of the cleat 115 may be matingly inserted. The stem 135 and cavity 145 may be cylindrical or any other corresponding shape. The stem 135 is thus held within the cavity 145 by the magnetic field and the magnetic attraction of the magnetic material in the stem 135 to the ferromagnetic material in the anchor 145.

The cleat 115 can be removed from the anchor 125 when a force sufficient to overcome the attractive force created by the magnet is experienced, as shown in FIG. 2C. In this way, during use in an athletic activity, if a sufficient force is experienced by the foot, the cleat releasing system 120 releases the cleat 115 enabling the sole 110 to slide on the ground with reduced traction. Under normal activity forces, such as those experience while running or doing other normal maneuvers, the cleat 115 remains in the anchor 125 and operates as a conventional cleat. The strength of the magnet and the resulting strength of the magnetic field determines the force necessary to release the cleat 115 from the anchor 125. Thus, the cleat releasing system 120 provides a system, method, and process for automating athletic shoe cleat release under unhealthy loads to prevent or minimize potential injuries while using cleats in over-stressed conditions. For example, if a football player hit by another player on his side attempts to maintain balance by leaning too much on an outside foot, the cleats can be designed to release before the shoe's grip force exceeds his lower leg injury limits. In one version, the force necessary to cause the cleat 115 to be released from the anchor 125 is from about 100 Newtons to about 2000 Newtons.

The cleat 115 can also be removed from the anchor 120 by a cleat removal tool 150, as shown in FIG. 2A. The cleat removal tool 150 allows the cleat 115 to be removed so that it can be stored and/or replaced by another cleat 115, such as a new cleat with reduced wear. The cleat 115 can otherwise be removed by a different shaped tool, such as pliers or the like.

In a particular version of the cleat releasing system 120 of FIGS. 2A and 2B, the force required to release the cleat can be adjustable. For example, multiple cleats 115, each having a stem 135 with a different magnetic strength can be provided. A wearer can thus select the releasing force desired and insert the cleat 115 with the corresponding magnetic strength into the anchor 120. Markings or indicia can be provided on the cleat 115 to indicate the releasing force for the cleat 115. For example, a first set of cleats 115 can be provided that have has one or more cleats with a release force of from about 100 Newtons to about 1500 Newtons, or from about 100 Newtons to about 1200 Newtons, or from about 100 Newtons to about 800 Newtons. A second set of cleats 115 can be provided that has one or more cleats 115 having a release force greater than the first set. In one version, the second set of cleats 115 has one or more cleats having a release force of from about 200 Newtons to about 2000 Newtons, or from about 400 Newtons to about 2000 Newtons, or from about 800 Newtons to about 2000 Newtons. In another version, a third, fourth, fifth, etc. set can be provided, each set with one or more cleats 115 having a different release force.

With the adjustable cleat releasing system 120, the user has the ability to adjust the overall cleat releasing system 120 for the entire athletic shoe 100. A user can select the releasing force for cleats 115 based on any number of factors such as the user's size, strength, experience level, competitive level, and the like. A young novice soccer player may desire a significantly lower releasing force than a World Cup athlete. Also, a user can use the adjustable cleat releasing system 120 to customize or tailor the user's athletic shoe 100 as desired. For example, a user may install cleats 115 having a first releasing force when participating in one sport and may change out the cleats 115 so as to have cleats 115 with a second, different releasing force when participating in a different sport. Also, a user may desire to have cleats 115 with different releasing forces at different locations on the sole 110 of the athletic shoe 100. For example, based on the way a user runs, there might be a location where the foot tends to stick in the ground more than others, and the user might want to have a cleat 115 associated with a lower releasing force in that location while having cleats 115 with higher releasing forces elsewhere on the sole 110. More specifically, athletes with a pronating foot strike may choose to set release forces lower on one or more cleats 115 near the inside of the athletic shoe 100, and athletes with a supinating foot strike may choose to set release forces lower on one or more cleats near the outside of the athletic shoe 100. Athletes who may be exposed to mostly head-on forces, such as football linemen, may choose to set cleat release forces higher near the ball of the foot because the calf muscles are less vulnerable to high head-on forces.

Alternatively, the materials of the cleat releasing system 120 can be reversed. For example, the magnetic material can be provided in the anchor 125 and the ferromagnetic material can be provided in the stem 135 of the cleat 115 or elsewhere in or on the cleat 115. In this version, it may be desirable to make the anchor 125 removable within the sole 110 so that different strength magnetic fields can be generated for customization purposes.

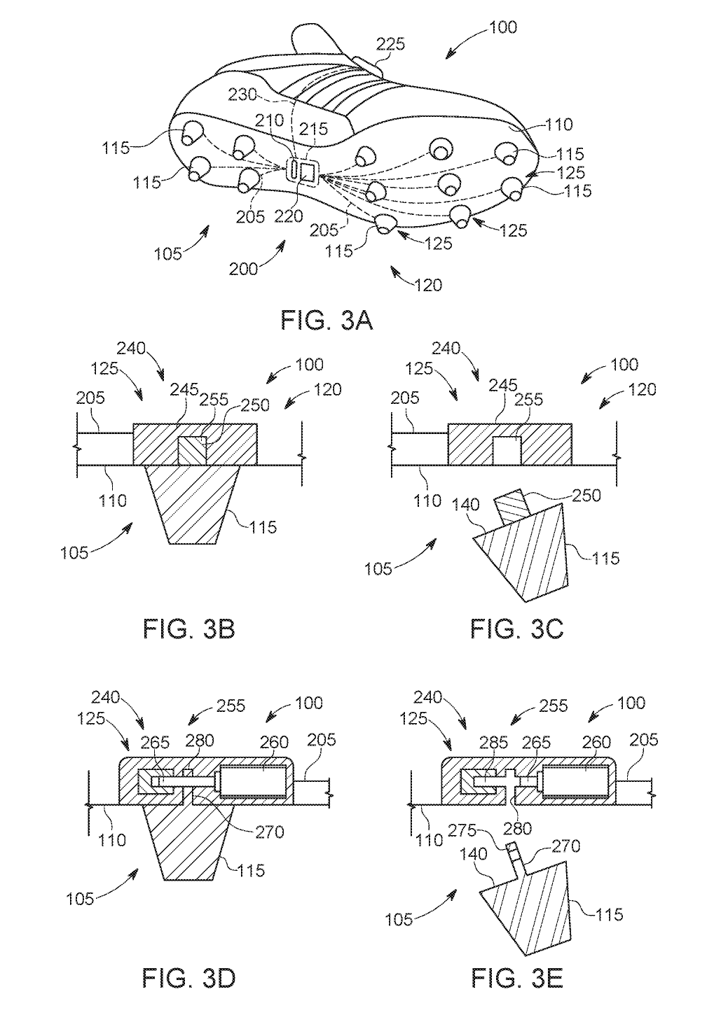

FIG. 3A shows another version of the athletic shoe 100. In this version the athlete shoe 100 has a cleat releasing system 120 that is electronically controllable. The cleat releasing system 120 of this version has an on-board microcontroller 200 that is in communication with one or more anchors 125 associated with a cleat 115. The microcontroller 200 is connected with the anchors 125 by one or more wires 205 or by wireless technology. One or more sensors 210, such as an accelerometer or other force detector, is provided on the athletic shoe 100 and the sensor 210 is in communication with a processing unit 215 of the microcontroller 200. The sensor 210 generates a signal indicative of the force being experienced by the athletic shoe 100 and sends the signal to the processing unit 215. The microcontroller 200 further includes a configurable memory buffer 220 and is powered by on-board battery 225, which may be disposed anywhere on the athletic shoe 100 such as on or near the shoe laces. The microcontroller 200 has firmware comprising, for example, C++ and the like and allows a user to interact with the microcontroller 200 remotely through one or more computing devices, such as one or more of a personal computer, a mobile device, a tablet, and the like, running known operating systems such as Windows, IOS, Google OS, Android and tablets, etc. running Windows, Apple, or Google software platforms, or the like. The firmware may also be programmable by a user allowing the user to define release load settings, such as those previously discussed, using the computing devices. The battery 225 may be composed of one or more of rechargeable lithium ion, nickel hydride, and the like. The battery 225 may be connected to the microcontroller by a wire 230 or the like. When the microcontroller 100 receives a signal from the sensor 210 indicative of a predetermined force, the microcontroller 100 causes the anchor 125 to release the cleat 115.

A version of an adjustable anchor system 240 that can be controlled by the microcontroller 200 of FIG. 3A is shown in FIG. 3B. In this version, the adjustable anchor system 240 is made up of an anchor 125 that is an electromagnet 245 and is connected to the microcontroller 200 by wire 205. An electromagnet is a coil of wire that acts as a magnet when an electric current passed through it. The strength of the electromagnet is related to the amount of current applied. The electromagnet 245 has a cavity 250 that receives a ferromagnetic stem 255 of the cleat 115. In use, the microcontroller 200 supplies the electromagnet 245 with current sufficient to generate a sufficiently strong magnetic field to retain the ferromagnetic stem 255 within the cavity 250. When the sensor 210 detects an undesirable force or other condition, such as any of the forces described above, the microcontroller stops the flow of current to and through the electromagnet 245 and the cleat 115 is thus released from the anchor 125, as shown in FIG. 3C.

Another version of an adjustable anchor system 240 that can be controlled by the microcontroller 200 of FIG. 3A is shown in FIGS. 3D and 3E. In this version, the adjustable anchor system 240 includes an anchor 125 housing a latching mechanism 255. In one particular version, the latching mechanism includes a solenoid 260 having a solenoid rod 265 that is extendable and retractable in response to a signal from the microcontroller 200 via wire 205 or the like. The cleat 115 has a latching stem 270 having an orifice 275 passing therethrough and sized to receive the solenoid rod 265. The latching stem 270 is receivable within a cavity 280 in the anchor so that the orifice 275 is aligned with a solenoid rod slot 285 through which the solenoid rod 265 travels when extending and retracting. When the solenoid rod 265 is extended and when the latching stem 270 is received within the cavity 280, the solenoid rod 265 passed through the orifice 275 and retains the cleat within the anchor 125 as shown in FIG. 3D. When the solenoid rod 265 is retracted, it no longer passes through the orifice 275, and the cleat 115 is releasable from the anchor 125, as shown in FIG. 3E. In use, the microcontroller 200 supplies the solenoid 260 with current sufficient to generate cause the solenoid rod 265 to extend to retain the latching stem 270 within the cavity 280. When the sensor 210 detects an undesirable force or other condition, such as any of the forces described above, the microcontroller 200 stops the flow of current to the solenoid 260 and the solenoid rod 265 is retracted thus releasing the cleat 115 from the anchor 125. The anchor 125 in this version is made of rigid but lightweight material such as plastic or the like.

In the versions of FIGS. 3A through 3E, the on-board microcontroller 200 receives cleat forces from the one or more sensors 210 in real time. When the forces exceed preset levels, the microcontroller 200 sends a release command to the anchor 125, thereby releasing the cleat 115. With this version, the user is also able to customize the cleat release system 120. For example, the user can adjust the release force based on the activity or other factor, as discussed above. The user can also set different release forces for multiple anchors 125. The user can have the ability to interact with the microcontroller 100 and can change the settings or release force strengths at various times on the fly. In one version, the selectable release forces can be any of those discussed above and can include different release forces for difference cleats 115 or groups of cleats 115. For example, a golfer who needs grip in a sand trap may set the cleat release force to be high. Once on the putting green the golfer can set the release force to be low so as not to interfere with the stroke on an even surface.

The cleat releasing system 120 of the present invention makes it possible to release an overloaded cleat individually and allow the athletic shoe 100 shoe to still function. For example, if a player is running along the sideline and exerts too much pressure on an outer side of a foot to remain in bounds, an outside cleat may release to relieve pressure while the other remain intact allowing the player to continue on his path.

Although the invention has been described in the context of protrusions in the form of cleats, the invention is applicable with any type or shape of protrusion or any other traction design. For example, the invention can be used textured sole basketball or tennis shoes. In those cases, the shoe and/or sole is useful in preventing basketball players and tennis players from sticking to the court and placing too much torque or other stress on knees and/or ankles.

Although the present invention has been described in considerable detail with regard to certain preferred versions thereof, other versions are possible, and alterations, permutations and equivalents of the version shown will become apparent to those skilled in the art upon a reading of the specification and study of the drawings. For example, the cooperating components may be reversed or provided in additional or fewer number. Also, the various features of the versions herein can be combined in various ways to provide additional versions of the present invention. Furthermore, certain terminology has been used for the purposes of descriptive clarity, not to limit the present invention. Therefore, any appended claims should not be limited to the description of the preferred versions contained herein and should include all such alterations, permutations, and equivalents as fall within the true spirit and scope of the present invention.

What is claimed is:

1. An athletic shoe comprising:
a sole comprising an anchor,
a protrusion attachable to the anchor, and
a releasing system adapted to release the protrusion from the anchor when a predetermined condition is experienced by the sole, wherein the releasing system comprises a portion of the protrusion that is receivable in the anchor and wherein the portion and the anchor are magnetically attracted to one another.

2. The athletic shoe according to claim 1, wherein the anchor comprises a cavity and wherein the portion comprises a stem that is receivable in the cavity.

3. The athletic shoe according to claim 1, wherein the protrusion is designed to provide improved traction to the sole when the protrusion is attached to the sole.

4. The athletic shoe according to claim 1, further comprising a plurality of anchors and a plurality of protrusions.

5. The athletic shoe according to claim 1, wherein the predetermined condition is a force and wherein the force is sufficiently large to overcome the magnetic attraction between the anchor and the portion of the protrusion.

6. The athletic shoe according to claim 5, wherein the force is from about 100 Newtons to about 2000 Newtons.

7. The athletic shoe according to claim 5, further comprising a plurality of anchors and a plurality of protrusions and wherein at least two protrusions require a different force to overcome the magnetic attraction between the protrusions and a corresponding anchor.

8. The athletic shoe according to claim 1, wherein the anchor comprises an electromagnet.

9. The athletic shoe according to claim 8, further comprising a sensor on the shoe that generates a signal related to the predetermined condition.

10. The athletic shoe according to claim 8, further comprising a microcontroller on the shoe, the microcontroller in communication with the electromagnet.

11. The athletic shoe according to claim 10, wherein the microcomputer is programmable and can adjust the electromagnet.

12. An athletic shoe comprising:
a sole comprising an anchor,
a protrusion attachable to the anchor, and
a releasing system adapted to release the protrusion from the anchor, wherein the releasing system comprises a sensor that detects a condition and wherein the releasing system causes the protrusion to be released from the anchor when the condition exceeds a predetermined level.

13. The athletic shoe according to claim 12, wherein the sensor detects a force experienced by the sole.

14. The athletic shoe according to claim 12, wherein the sensor is an accelerometer.

15. The athletic shoe according to claim 12, wherein the releasing system comprises a programmable microcomputer that can adjust the predetermined level.

16. The athletic shoe according to claim 12, wherein the releasing system comprises a electromagnet and wherein a portion of the protrusion is attracted to the electromagnet when a current is supplied to the electromagnet.

17. The athletic shoe according to claim 12, wherein the releasing system comprises a latching mechanism, wherein the latching mechanism latches the protrusion to the anchor when the condition is below the predetermined level and unlatches the protrusion when the condition exceeds the predetermined level.

18. A method for providing selective traction for a user wearing an athletic shoe, the method comprising:
providing an athletic shoe with a sole having a protrusion extending from its sole,
detecting a condition, and
causing the sole to have reduced traction when the detected condition exceeds a predetermined level.

19. The athletic shoe according to claim 18, wherein the sole is caused to have reduced traction by the release of the protrusion from the sole.

20. The athletic shoe according to claim 18, wherein the predetermined level is adjustable.
